(19) United States
(12) Patent Application Publication
(10) Pub. No.: US 2007/0200616 A1
(43) Pub. Date: Aug. 30, 2007

(54) Band-gap reference voltage generating circuit

(75) Inventor: Yoon-Jae Shin, Gyeonggi-do (KR)

Correspondence Address: VENABLE LLP, P.O. BOX 34385, WASHINGTON, DC, 20043-9998, US

(73) Assignee: Hynix Semiconductor Inc., Gyeonggi-do (KR)

(21) Appl. No.: 11/637,924

(22) Filed: Dec. 13, 2006

(30) Foreign Application Priority Data
Feb. 28, 2006 (KR) 10-2006-0019445

(51) Int. Cl. G05F 1/10; G05F 3/02

(52) U.S. Cl. 327/539

(57) ABSTRACT

A band-gap reference voltage generating apparatus is disclosed. The band-gap reference voltage generating apparatus according to the present invention includes an operational amplifier unit that is driven by a bias voltage and outputs an operational amplifying signal using a first voltage and a second voltage as input voltages; a voltage generating unit that generates the first voltage and the second voltage in response to the operational amplifying signal; a reference voltage generating unit that outputs a reference voltage in response to the operational amplifying signal; and a unit that feedbacks the reference voltage to generate as the bias voltage.

### BACKGROUND OF THE INVENTION

1. Technical Field

The present invention relates to a semiconductor integrated circuit, in particular, to a band-gap reference voltage generating circuit that is insensitive to a change of a power supply voltage.

2. Related Art

A band-gap reference voltage generating circuit (hereinafter, referred to as “BGR” circuit) is applied to a semiconductor integrated circuit to supply a stable bias. The BGR circuit mainly supplies a reference voltage to an analog-digital converter (ADC) or a digital-analog converter (DAC) and provides the stable reference voltage to the ADC and DAC even if there is a change in the temperature or the process. In recent years, as portable devices that are driven by using batteries are widely used, demands for low power consumption and low power operation have been increased. In response to the above demands, as the power supply voltage level is decreased to 1.5 to 2.0 V, it is expected that the level of the reference voltage generated in the BGR circuit is also decreased to 1.25 V or 1.0 V or less.

FIG. 1 is a circuit diagram of a BGR circuit according to the related art.

Referring to FIG. 1, the BGR circuit according to the related art includes a bias circuit 110 that supplies a bias VBIAS; an operational amplifier (OP AMP) 120 that is driven by the bias voltage VBIAS and outputs an operational amplifying signal amp using a first voltage Va and a second voltage Vb as an input; a first voltage generating unit 130 that outputs the first voltage Va in response to the operational amplifying signal amp; a second voltage generating unit 140 that outputs the second voltage Vb in response to the operational amplifying signal amp; and a reference voltage generating unit 150 that outputs a reference voltage VREF in response to the operational amplifying signal amp.

In the BGR circuit, the amount of current that is supplied to a resistor through MOS transistors MP3, MP4, and MP5 is controlled by the turn-on order of the MOS transistors MP3, MP4, and MP5. Also the turn-on order of the MOS transistors MP3, MP4, and MP5 is determined on the basis of the output voltage of the operational amplifier 120. This operation continues until voltages having the same level are applied to the two input terminals of the operational amplifier 120. When voltages having the same level are applied to the two input terminals of the operational amplifier 120, a constant level reference voltage VREF is generated.

In FIG. 1, the MOS transistors MP3, MP4, and MP5 have the same size, and the resistors R1 and R2 have the same resistance. The operational amplifier 120 controls the first voltage Va and the second voltage Vb to be equal to each other. Therefore, currents I1, I2, and I3 that flow through the PMOS transistors MP3, MP4, and MP5 that are driven by the operational amplifying signal and whose gates are connected to the output node e of the operational amplifier have the same value. In this case, I1a=I2a, and I1b=I2b.

The reference voltage VREF is calculated by the following Equation 1.

$${dV}_{BE} = {V}_{BE 1} - {V}_{BE 2} = {V}_{T} \cdot ln ( N ) \\ I 2 a = \frac{{dV}_{BE}}{R 3} = \frac{{V}_{T} \cdot ln ( N )}{R 3} \\ I 2 b = \frac{{dV}_{BE 1}}{R 2} \\ I 3 = I 2 = I 2 a = I 2 b \\ VREF = R 4 [ \frac{{V}_{BE 1}}{R 2} + \frac{{dV}_{BE}}{R 3} ] = \frac{R 4}{R 2} [ {V}_{BE 1} + \frac{R 2}{R 3} {dV}_{BE} ] \qquad Equation 1$$

Meantime, a circuit that biases using the MOS transistors as a current source, or a circuit that biases using an output voltage of a Widlar circuit is used as the bias circuit 110.

FIG. 2 is an example of a bias circuit 110 that biases using the MOS transistors as a current source.

Referring to FIG. 2, the bias circuit 110 is connected between a power supply terminal VDD and a ground terminal VSS. The bias circuit 110 includes a PMOS transistor MP6 connected to operate as a diode and a resistor R5a. The bias voltage VBIAS of the operational amplifier 110 is output from a connection node between the PMOS transistor MP6 and the resistor R5a.

The bias voltage VBIAS is represented by a voltage level that is dropped from the power supply voltage VDD by a threshold voltage Vth of the PMOS transistor MP6, that is, VDD-Vth. Therefore, the level of the bias voltage VBIAS may be changed depending on the level of the power supply voltage VDD.

When the bias voltage VBIAS is changed depending on the level of the power supply voltage VDD, the operational currents I1, I2, and I3 are also changed.

However, there is a problem in that the change of the output reference current I3 causes a change of the reference voltage VREF. That is, when the level of the power supply voltage VDD is elevated, the gate voltage of the NMOS transistor MN3 that configures a current sink of the operational amplifier 100 is also elevated. Therefore, since the NMOS transistor MN3 operates as a triode mode in a saturation region, a stable reference voltage VREF can not be output.

A bias circuit that uses an output voltage of the Widlar circuit also has the same problem because the bias voltage VBIAS is changed depending on the level of the power supply voltage VDD.

Therefore, a BGR circuit that is insensitive to the change of the level of the power supply voltage VDD is required.

### SUMMARY OF THE INVENTION

An embodiment of the present invention provides a BGR circuit that is insensitive to the change of the level of the power supply voltage VDD.

Another embodiment of the present invention provides a BGR circuit that has a simple structure by dividing the output of the reference voltage using a resistor to bias an operational amplifier.

According to an embodiment of the present invention, there is provided a BGR circuit that includes an operational amplifier unit that is driven by a bias voltage and outputs an operational amplifying signal using a first voltage and a second voltage as input voltages; a voltage generating unit that generates the first voltage and the second voltage in response to the operational amplifying signal; a reference voltage generating unit that outputs a reference voltage in response to the operational amplifying signal; and a unit that feedbacks the reference voltage to generate as the bias voltage.

According to another embodiment of the present invention, there is provided a BGR circuit that includes an operational amplifier unit that is driven by a bias voltage and outputs an operational amplifying signal using a first voltage and a second voltage as input voltages; a voltage generating unit that generates the first voltage and the second voltage in response to the operational amplifying signal; a reference voltage generating unit that outputs a reference voltage in response to the operational amplifying signal; and a unit that divides the reference voltage using a resistor to generate as the bias voltage.

### BRIEF DESCRIPTION OF THE DRAWINGS

FIG. 1 is a circuit diagram illustrating a BGR circuit according to the related art.

FIG. 2 is a circuit diagram illustrating a typical bias circuit.

FIG. 3 is a circuit diagram illustrating a BGR circuit according to an exemplary embodiment of the present invention.

FIG. 4 is a graph illustrating a simulation result of a stable bias voltage VREF1 produced according to the embodiment of the present invention.

FIGS. 5A and 5B are graphs illustrating a DC simulation result of BGR circuits according to the related art and the embodiment of the present invention.

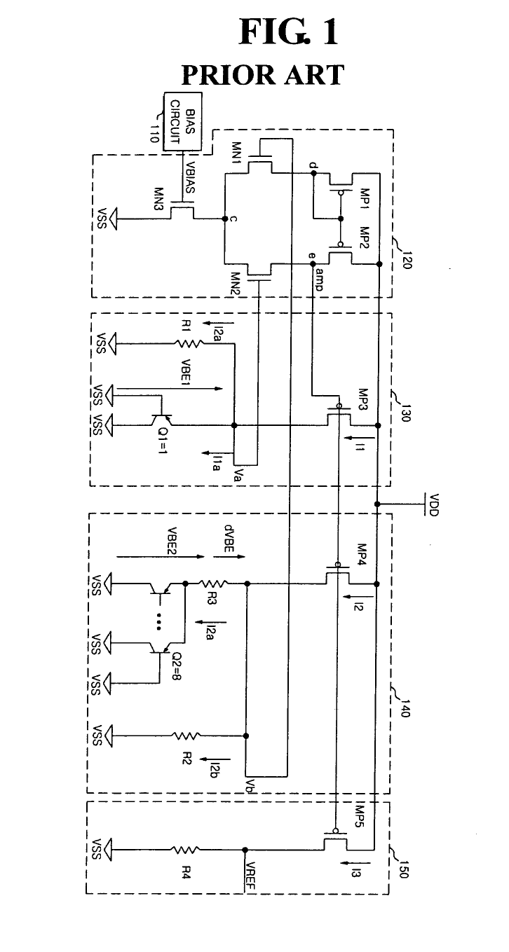

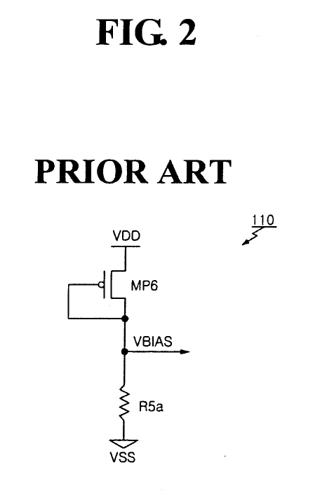

### DESCRIPTION OF EXEMPLARY EMBODIMENTS

Hereinafter, preferred embodiments of the present invention will be described in detail with reference to the accompanying drawings. The invention may, however, be embodied in many different forms and should not be constructed as being limited to the embodiments se forth herein: rather, these embodiments are provided so that this disclosure will be through and complete, and will fully convey the concept of the invention to those of ordinary skill in the art.

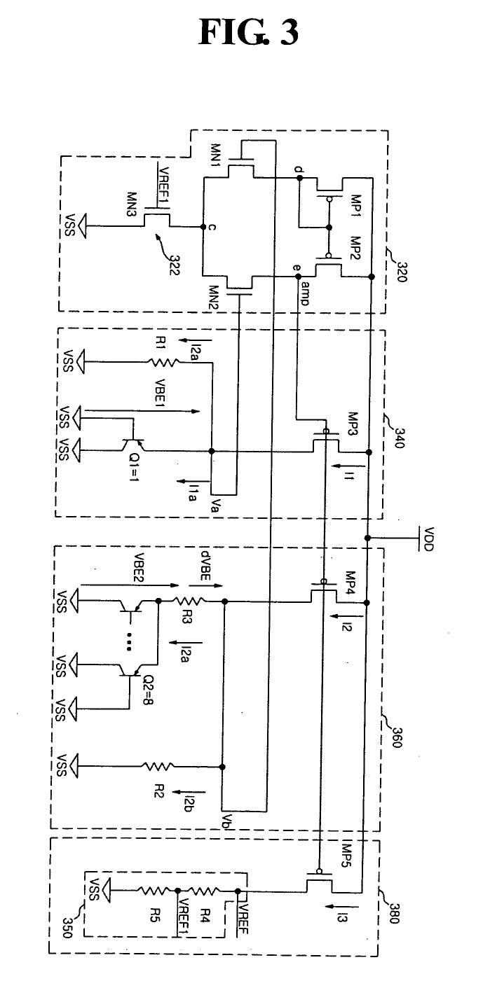

Referring to FIG. 3, a BGR circuit according to an embodiment of the present invention includes an operational amplifier 320, voltage generating units 340 and 360, a reference voltage generating unit 380, and a bias voltage generating unit 350 that feedbacks a reference voltage VREF to generate a bias voltage VREF1. In this embodiment, the reference voltage VREF is divided by resistors R4 and R5 to generate the bias voltage VREF1.

More specifically, the reference voltage generating unit 380 may include a PMOS transistor MP5 whose source is connected to the power supply voltage VDD and drain is connected to an output node of the reference voltage VREF and whose gate receives an output signal of operational amplifying signal amp; and the bias voltage generating unit 350 having resistors R4 and R5. The resistor R4 and R5 are connected in series between the reference voltage output node and the ground terminal.

As mentioned above, the bias voltage VREF1 is generated in the bias voltage generating unit 380. The bias voltage VREF1 is a voltage at a node between the resistors R4 and R5.

The operational amplifier unit 320 is driven by the bias voltage VREF1 and outputs an operational amplifying signal amp using the first voltage Va and the second voltage Vb as input voltages. The operational amplifier unit 320 includes a current sink 322 to which the bias voltage VREF1 is applied. The current sink 322 may be configured by an NMOS transistor or a PMOS transistor to which the bias voltage VREF1 is applied through its gate.

In this embodiment, the operational amplifier 320 includes a first PMOS transistor MP1 in which a source is connected to the power supply voltage terminal VDD and a gate and drain are connected to a common node, and a second PMOS transistor MP2 in which a source is connected to the power supply voltage terminal, a drain is connected to the output node operational amplifier and a gate is connected to the gate of the first PMOS transistor MP1. The operational amplifier 320 further includes a first NMOS transistor MN1 in which a drain is connected to the drain node ‘d’ of the first PMOS transistor MP1 and a gate receives the second voltage Vb, a second NMOS transistor MN2 in which a drain is connected to the output node ‘e’ of the operational amplifying signal amp and a gate receives the first voltage Va, and a third NMOS transistor MN3 in which a source is connected to the common source of the first and second NMOS transistors MN1 and MN2, a drain is connected to the ground terminal Vss, and a gate is applied to the bias voltage VREF1.

The voltage generating unit is configured by a first voltage generating unit 340 that generates the first voltage Va in response to the operational amplifying signal amp; and a second voltage generating unit 360 that generates the second voltage Vb in response to the operational amplifying signal amp.

The first voltage generating unit 340 is configured by a third PMOS transistor MP3 in which a source is connected to the power supply voltage terminal VDD, a drain is connected to the first voltage Va terminal and a gate receives the operational amplifying signal amp; a diode Q1 whose one terminal is connected to the ground terminal; and a resistor R1 that is connected between the first voltage Va terminal and the ground terminal Vss.

The second voltage generating unit 360 is configured by a fourth PMOS transistor MP4 in which a source is connected to the power supply voltage terminal VDD, a drain is connected to the second voltage Vb terminal and a gate receives the operational amplifying signal amp; a plurality of diodes Q2 whose one ends are connected to the ground terminal and that are connected in parallel to each other; a resistor R2 that is connected between the second voltage Vb terminal and the ground terminal Vss; and a resistor R3 whose one end is connected to the other ends of the diodes Q2 and the other end is connected to the second voltage Vb terminal.

As described above, a method of generating the bias voltage VREF1 by the operational amplifier unit 320 is different from the related art.

That is, in the BGR circuit according to this embodiment, as the turn-on condition(i.e., turn-on voltage) of the MOS transistors MP3, MP4, and MP5 is changed in accordance with the output voltage of the operational amplifier unit 320, the amount of currents I1, I2, and I3 that are supplied to the resistors through the MOS transistors MP3, MP4, and MP5 is controlled. This operation continues until voltages having the same level (Va=Vb) are applied to the two input terminals of the operational amplifier 320. When the voltages having the same level are applied to the two input terminals of the operational amplifier 120, a constant level reference voltage VREF is generated. The MOS transistors MP3, MP4, and MP5 have the same size, and the resistors R1 and R2 have the same resistance. The operational amplifier 320 controls the first voltage Va and the second voltage Vb to be equal to each other. Therefore, currents I1, I2, and I3 that flow through the PMOS transistors MP3, MP4, and MP5 that are driven by the operational amplifying signal and whose gates are connected to the output node e of the operational amplifier have the same value. In this case, I1a=I2a, and I1b=I2b.

The reference voltage VREF is determined by using Equation 1 as described above.

Further, the bias voltage VREF1 is determined by the following Equation 2.

$$VREF 1 = \frac{R 5}{R 4 + R 5} VREF \qquad Equation 2$$

That is, the reference voltage VREF that is insensitive to PVT (process, supply voltage, temperature) is divided by the resistors R4 and R5, to generate the voltage VREF1. And then the voltage VREF1 is applied to the gate of the third NMOS transistor MN3 for the current sink of the operational amplifier unit 320. Accordingly, it is possible to ensure a stable reference voltage VREF even when the power supply voltage VDD is changed. Further, it is possible to output the reference voltage VREF that is stable even when the skew of the third NMOS transistor NM3 is changed.

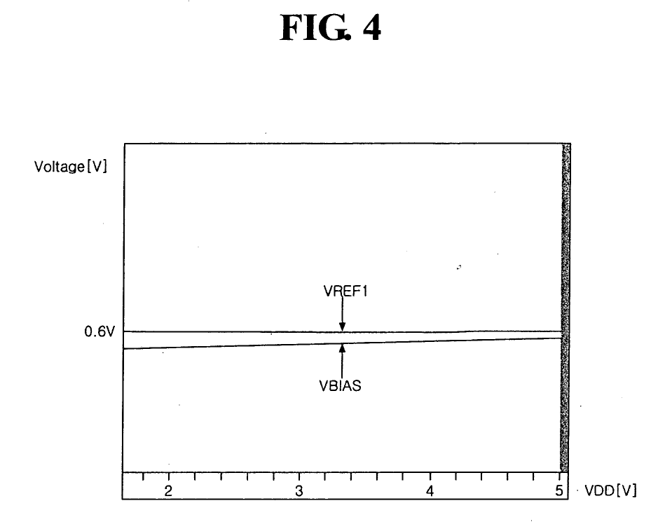

FIG. 4 is a graph illustrating a simulation result that the bias voltage VBIAS according to the related art and the bias voltage VREF1 according to this embodiment are changed as the power supply voltage VDD is changed. As compared with the related art, according to an embodiment of the present invention, the bias voltage VREF1 is substantially insensitive to the change of the power supply voltage to generate a voltage of 0.6 V.

This allows the NMOS transistor that is the current sink of the operational amplifier to be operated in a saturation region. That is, it prevents the NMOS transistor from entering the triode region.

As a result, there is no change in the operational currents I1, I2, and I3. Specifically, since there is no change in the output reference current I3, it is possible to prevent the occurrence of the change of the reference voltage VREF.

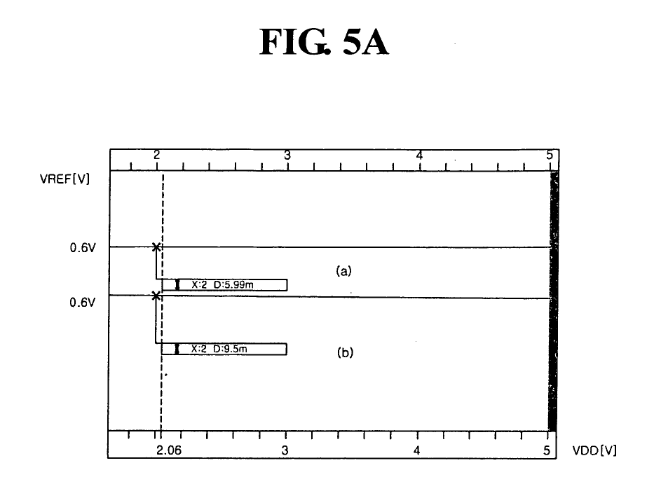

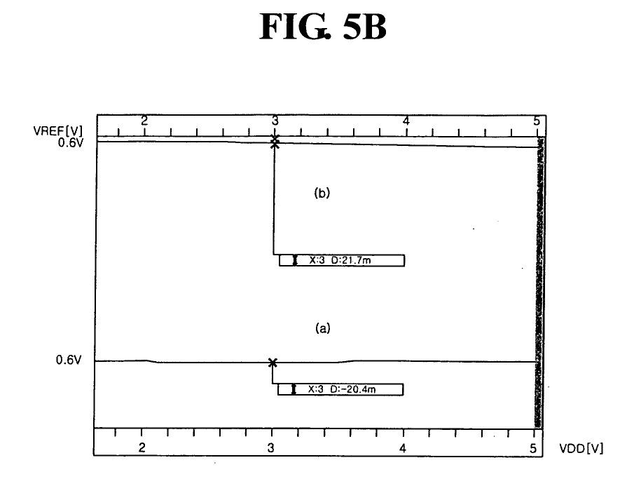

FIGS. 5A and 5B are graphs illustrating a DC simulation result of BGR circuits according to the related art and an embodiment of the present invention.

FIG. 5A shows a VDD sweep result when TT and TT skew of a parasitic BJT are applied at −40° C., −10° C., 25° C., 90° C., and 125° C. The change of the output reference voltage VREF is smaller in the present embodiment than in the related art.

FIG. 5B shows a VDD sweep result when FF, SS, TT, FS, SF and all skews of the parasitic BJT are applied at 25° C. The change of the output reference voltage VREF is also smaller in the present embodiment than in the related art. In FIG. 5A and FIG. 5B, (a) represents the embodiment of the present invention and (b) represents the related art.

In this embodiment, the circuit structure of the technical components that configure the operational amplifier unit, the voltage generating unit, and the reference voltage generating unit may be different from FIG. 3, and modified in various types.

It will be apparent to those skilled in the art that various modifications and changes may be made without departing from the scope and spirit of the present invention. Therefore, it should be understood that the above embodiments are not limiting, but illustrative in all embodiments. The scope of the present invention is defined by the appended claims rather than by the description preceding them, and therefore all changes and modifications that fall within metes and bounds of the claims, or equivalents of such metes and bounds are therefore intended to be embraced by the claims.

According to this invention, the reference voltage VREF is feedback or divided by a resistor to be applied to the operational amplifier as a bias voltage. As a result, it is possible to generate a stable reference voltage that is insensitive to the change of the power supply voltage VDD and an additional complex bias circuit is not required.

What is claimed is:

1. A band-gap reference voltage generating apparatus comprising:
an operational amplifier unit configured to be driven by a bias voltage and output an operational amplifying signal using a first voltage and a second voltage as input voltages;
a voltage generating unit configured to generate the first voltage and the second voltage in response to the operational amplifying signal;
a reference voltage generating unit configured to output a reference voltage in response to the operational amplifying signal; and
a unit configured to feed back the reference voltage to the operational amplifier unit as the bias voltage.

2. The apparatus of claim 1, wherein the operational amplifier unit includes a current sink to which the bias voltage is applied.

3. The apparatus of claim 2, wherein the current sink comprises an NMOS transistor or a PMOS transistor having a gate to which the bias voltage is applied.

4. The apparatus of claim 1, wherein the reference voltage generating unit includes:
a PMOS transistor having a source connected to the power supply voltage terminal, a drain, and a gate configured to receive the operational amplifying signal; and
first and second resistors connected in series between the drain of the PMOS transistor in the reference voltage generating unit and a ground terminal.

5. The apparatus of claim 4, wherein the reference voltage generating comprises a connection node between the first and second resistors and the bias voltage generating unit configured to generate a voltage at the connection node as the bias voltage.

6. The apparatus of claim 1, wherein the operational amplifier unit includes:
a first PMOS transistor having a source connected to a power supply voltage terminal and a gate and a drain connected to a common node;
a second PMOS transistor having a source connected to the power supply voltage terminal, a drain connected to an output node of the operational amplifier unit, and a gate connected to the gate of the first PMOS transistor;
a first NMOS transistor having a drain connected to the drain of the first PMOS transistor, a source, and a gate configured to receive the second voltage;
a second NMOS transistor having drain is connected to the output node, a source connected to the source of the first NMOS transistor and a gate configured to receive the first voltage; and
a third NMOS transistor having a drain connected to the sources of the first and second NMOS transistors, a source connected to the ground terminal, and a gate configured to receive the bias voltage.

7. The apparatus of claim 1, wherein the voltage generating unit includes:
a first voltage generating unit configured to generate the first voltage in response to the operational amplifying signal; and
a second voltage generating unit configured to generate the second voltage in response to the operational amplifying signal.

8. The apparatus of claim 7, wherein the first voltage generating unit includes:
a PMOS transistor having a source connected to a power supply voltage terminal, a drain connected to a terminal for the first voltage, and a gate configured to receive the operational amplifying signal;
a diode having one terminal connected to a ground terminal; and
a resistor connected between the first voltage terminal and the ground terminal.

9. The apparatus of claim 7, wherein the second voltage generating unit includes:
a PMOS transistor having a source connected to the power supply voltage terminal, a drain connected to a terminal for the second voltage and a gate configured to receive the operational amplifying signal;
a plurality of diodes having respective first ends connected to the ground terminal in parallel to each other and second ends;
a first resistor having a first end connected to the second ends of the diodes and a second end connected to the second voltage terminal; and
a second resistor connected between the second voltage terminal and the ground terminal.

10. A band-gap reference voltage generating apparatus comprising:
an operational amplifier unit configured to be driven by a bias voltage and output an operational amplifying signal using a first voltage and a second voltage as input voltages;
a voltage generating unit configured to generate the first voltage and the second voltage in response to the operational amplifying signal;
a reference voltage generating unit configured to output a reference voltage in response to the operational amplifying signal; and
a unit configured to divide the reference voltage by a resistor, to generate as the bias voltage.

11. The apparatus of claim 10, wherein operational amplifier unit includes a current sink to which the bias voltage is applied.

12. The apparatus of claim 11, wherein the current sink comprises an NMOS transistor or a PMOS transistor having a gate to which the bias voltage is applied.

13. The apparatus of claim 10, wherein the reference voltage generating unit includes:
a PMOS transistor having a source connected to a power supply voltage terminal, a drain connected to an output node of the reference voltage generating unit, and a gate configured to receive the operational amplifying signal; and
first and second resistors connected in series between the output node of the reference voltage generating unit and a ground terminal, and wherein
the reference voltage is output from the output node.

14. The apparatus of claim 13, wherein the reference voltage generating unit comprises a connection node between the first and second resistors and the bias voltage generating unit configured to generate a voltage at the connection node as the bias voltage.

15. The apparatus of claim 10, wherein the operational amplifier unit includes:
a first PMOS transistor having a source connected to a power supply voltage terminal and a gate and a drain connected to a common node;
a second PMOS transistor having a source connected to the power supply voltage terminal, a drain connected to an output node of the operational amplifier unit, and a gate connected to the gate of the first PMOS transistor and;
a first NMOS transistor having a drain connected to the drain of the first PMOS transistor, a source, and a gate configured to receive the second voltage;
a second NMOS transistor having a drain connected to the output node of the operational amplifier unit, a source connected to the source of the first NMOS transistor, and a gate configured to receive the first voltage; and
a third NMOS transistor having a source is connected to the sources of the first and second NMOS transistors, a drain is connected to the ground terminal, and a gate receives the bias voltage.

16. The apparatus of claim 10, wherein the voltage generating unit includes:
a first voltage generating unit that generates the first voltage in response to the operational amplifying signal; and
a second voltage generating unit that generates the second voltage in response to the operational amplifying signal.

17. The apparatus of claim 16, wherein the first voltage generating unit includes:
a PMOS transistor whose a source is connected to a power supply voltage terminal, a drain is connected to a terminal for the first voltage and a gate receives the operational amplifying signal;
a diode whose one terminal is connected to a ground terminal; and
a resistor connected between the terminal for the first voltage and the ground terminal.

18. The apparatus of claim 16, wherein the second voltage generating unit includes:
a PMOS transistor having a source connected to the power supply voltage terminal, a drain connected to a terminal for the second voltage and a gate configured to receive the operational amplifying signal;
a plurality of diodes having respective first ends connected to the ground terminal parallel to each other;
a first resistor having a first end connected to the other ends of the diodes and a second end connected to the terminal for the second voltage; and
a second resistor connected between the second voltage terminal and the ground terminal.

19. A band-gap reference voltage generating apparatus that generates a reference voltage, comprising:
an operational amplifier unit configured to be driven by a bias voltage and output an operational amplifying signal using a first voltage and a second voltage as input voltages;
a first PMOS transistor having a source connected to the power supply voltage, a drain connected to a first voltage and a gate connected to receive the operational amplifying signal;
a second PMOS transistor having a source connected to the power supply voltage, a drain connected to a second voltage and a gate connected to receive the operational amplifying signal;
a third PMOS transistor having a source connected to the power supply voltage, a drain connected to a reference voltage and a gate connected to receive the operational amplifying signal;
a first resistor connected between a terminal for the first voltage and a ground voltage;
a first diode connected between the terminal for first voltage and the ground voltage;
a second resistor connected between a terminal for the second voltage and the ground voltage;
a third resistor and a second diode group connected in series between the terminal for the second voltage and the ground voltage; and
a fourth resistor and a fifth resistor connected in series between the reference voltage and the ground voltage;
wherein a voltage of a connection node between the fourth resistor and the fifth resistor is the bias voltage,
wherein the bias voltage is fed back to the operational amplifier.

20. The apparatus of claim 19, wherein the first, second, and third PMOS transistors have substantially the same size.

21. The apparatus of claim 19, wherein the first and second resistors have substantially the same resistance.

22. The apparatus of claim 19, wherein the second diode group includes a plurality of diodes connected in parallel to each other.
